(19) United States
(12) Patent Application Publication
(10) Pub. No.: US 2009/0075843 A1
(43) Pub. Date: Mar. 19, 2009

(54) Biological Sensor System

(75) Inventors: Frank Yue Jiang, Lubbock, TX (US); Zhaoyang Fan, Lubbock, TX (US)

Correspondence Address: LATHROP & GAGE LC, 2345 GRAND AVENUE, SUITE 2800, KANSAS CITY, MO, 64108, US

(73) Assignee: III-N Technology, Inc.

(21) Appl. No.: 12/210,287

(22) Filed: Sep. 15, 2008

Related U.S. Application Data
(60) Provisional application No. 60/972,273, filed on Sep. 14, 2007.

(51) Int. Cl. C40B 60/12

(52) U.S. Cl. 506/39

(57) ABSTRACT

Disclosed is a system using each of the descrete emitters in a III-nitride micro-emitter array as a light source for measuring the properties of independent samples of biological materials deposed on a micro-array using some form of detecting device, e.g, a detector array or charge-coupled device. In embodiments the emitter array produces deep ultraviolet in investigating protein-protein interactions or to detect biological and chemical molecules with high specificity by monitoring changes in a protein's intrinsic fluorescence.

### CROSS-REFERENCE TO RELATED APPLICATIONS

This application claims the benefit of U.S. Provisional Patent Application No. 60/972,273 filed Sep. 14, 2007, the entire disclosure of which is herein incorporated by reference.

### BACKGROUND OF THE INVENTION

1. Field of the Invention

The invention relates generally to the field of biological testing. More specifically, the invention relates to the field of using detectors to evaluate arrays of biological materials which have been subjected to some form of electromagnetic radiation.

2. Description of the Related Art

One area of related art is in the field of DNA testing applications. Recently, a great deal of attention has been focused on the research and development of micro-array or micro-assay techniques, which use an array of DNA or protein related probes, also known as “spots,” which are biological materials deposited robotically using techniques adapted from the semiconductor industry, or printed using ink-jet printer technology, to determine the absence or presence of certain proteins or DNA in biological samples in a highly parallel fashion. In application, the micro-array is exposed to a solution containing single strand DNA (“ssDNA”) molecules of unknown sequence, called targets, which are labeled with fluorescent dyes. Due to specific molecular recognition among the base pairs in the DNA, binding or hybridization occurs only when the probe and target sequences are complementary. The nucleotide sequence of the target is determined by the probe whose sequence is known if binding happens on the particular sample at that spot. By imaging fluorescence, binding or unbinding can be detected. Most current technologies for DNA sequencing use laser-induced fluorescence for detecting the presence of a particular gene sequence.

In one conventional system, a DNA-array read system (or scanner) includes a laser diode for excitation of the fluorescent dyes, and a detection system to detect the fluorescence to distinguish between different DNA bases. DNA micro-array technology provides a method that expedites gene sequencing by over 100-fold compared to traditional approaches. For example, antibodies, nucleic acids, receptors, enzymes, and proteins can be spotted onto chips to form micro-arrays and can be used as capture molecules for protein study. Because many different capture molecules can be placed on a single micro-assay biochip, the biochip is capable of testing for many diseases/anomalies at once. Applications of the micro-assay biochip include gene discovery, disease diagnosis, drug discovery (pharmaceutical research), forensics, and toxicology to name a few.

Current technology uses either (1) a laser scanning in conjunction with a photo-multiplier-tube (“PMT”) to scan each pixel one by one, or (2) a filtered lamp together with a Charged-Coupled-Device (“CCD”) camera to scan sections of a micro-array. Laser scanners can scan images with excellent spatial resolution, but due to their nature, can only scan pixels individually and scanning an entire micro-array still takes a long time to complete, due to the vast number of DNA probes involved. A filtered lamp together with a CCD camera, on the other hand, can scan an entire micro-array more quickly, but spatial resolution becomes hindered due to crosstalk, which is the interference between neighboring testing spots. DNA micro-arrays based on current technologies are also bulky and expensive due to the use of discrete component systems (DNA micro-array, light source, and detector), which limits the ability of wide spread use of DNA micro-arrays in many key applications. Additionally, to obtain suitably high standards of performance, present systems require the intervention of skilled operators. Slowness and high costs of these systems have prevented these conventional systems from becoming routinely used in the art of individual medicine.

Another area of technology relevant to this disclosure is the use of sensors for label-free protein detection. Fluorescence-labeled DNA micro-array technologies have enabled parallel analysis of the many genes within a living system and the detection of a few macromolecules. However, an extrinsic tag, such as a fluorescent molecule, may change properties of a host macromolecule. The significance of such a change is often not known. This is particularly relevant when studying properties of proteins. Since any application of a protein chip must involve a suitable labeling strategy that will permit the observation of activities, fluorescent tags have been commonly used to identify protein-protein interactions. The use of labels has limitations, including possible need for additional steps in an assay, difficulty in detecting certain biochemical activities, and possible inability to identify unanticipated activities. Subtle changes in binding affinities and associated kinetics of protein molecules, by added physical properties of an extrinsic tag or through tag-induced conformational changes in protein molecules, can have a significant influence on some functions of protein molecules. Furthermore, the dye and tagging processes now in use are expensive, making the cost of protein chips inhibitive for clinical testing.

To avoid chemical alteration of the biomolecules involved, a few techniques for label-free detection have been proposed. These include imaging ellipsometry and diffraction based methods, surface plasmon resonance, mass spectrometry, and nanomechanical methods. Label-free detection offers two essential advantages: (i) modifications of proteins are kept to a minimum, and (ii) minute amounts of interesting proteins are not diminished further by reaction and purification steps. It has been previously demonstrated that the above mentioned label-free detection methods can be complemented by a new analytical approach based on an intrinsic fluorescence of proteins that takes advantage of direct excitation of intrinsic aromatic amino acids, particularly tryptophan and tyrosine, as these amino acids have their absorption maximum around 280 nm and fluoresce above 300 nm. The measurements have been performed using a 280 nm UV-laser as an excitation source. The technique makes uses of changes of fluorescence decay times of the protein's intrinsic fluorophores, tryptophan and tyrosine, due to protein-protein interaction. Changes of intrinsic fluorescence intensity can also be utilized as an additional parameter for signal detection. Using a protein's intrinsic, fluorescence based, label-free characteristics for analyzing protein micro-arrays offers broad applicability ranging from principal investigations of protein interactions to applications in molecular biology and medicine.

However, so far, deep UV light of shorter than 280 nm in wavelength has been obtained from the output of a frequency-tripled mode-locked Ti:Sapphire Laser. Thus, the present detection systems based on proteins intrinsic fluorescence are very large, heavy, fragile, high cost, and require intervention by highly-skilled operators.

### SUMMARY

The present invention is defined by the claims below. Embodiments of the disclosed systems and methods include a sensor system for determining a characteristic in a chemical or biological substance. The system includes a sample-deposition member being locatable between a micro-emitter array and an electromagnetic-radiation-measuring detector. The sample-deposition member includes a first sample deposit. The micro-emitter array includes a first discrete emitting element, and the detector includes a first-detecting element positioned to receive a reading from the first sample after the first sample has been irradiated by a first source of electromagnetic energy originating from the first discrete emitting element.

In embodiments a second sample deposit can exist on the deposition member; a second discrete emitting element on the micro-emitter array; and a second-detecting element positioned to to receive a reading from the first second sample after the second sample has been irradiated by a second source of electromagnetic energy originating from the second discrete emitting element. Further, at least one of the first discrete emitting element and the second discrete emitting element can be adapted to emit UV electromagnetic energy. Further, at least one of the first discrete emitting element and the second discrete emitting element can emit at wavelengths of approximately 280 nm.

In embodiments a plurality of individual emitters in the micro-emitter array are adapted to be individually turned on and off. In other embodiments the detector is one of a detector array and a CCD. Further, the detector can include a read out integrated circuit.

In some embodiments, the micro-emitter array and the detector are arranged such that the sample-deposition member is removeable and replaceable. Also, a microlens may be deposed on the first discrete emitting element to focus electromagnetic energy emitted on the first sample. Also in embodiments, a substrate on which the first discrete emitting device is mounted includes a driver-circuit arrangement necessary to electrically control the first discrete emitting element.

The first discrete emitting element may be mounted on a first surface of a substantially transparent substrate, the substantially transparent substrate being flip-chip mounted onto a primary substrate, the primary substrate including driver circuitry. Additionally, in embodiments, electrical connections between the first discrete emitting element and a plurality of other discrete light emitting elements and the driver circuitry on the primary substrate are made using indium bumps. Further, embodiments may include an opposite side of the substantially transparent substrate defines at least one microlens for columnating the electromagnetic energy emitted from the first discrete emitting element on to the first sample.

In other embodiments the micro-emitter array is constructed of III-nitride materials. In some embodiments, the micro-emitter array is a III-nitride micro-emitter array. In still further embodiments, the micro-emitter array is constructed of InAlGaN alloy materials.

In other alternative embodiments the substance to be tested is deposed on the emitters. More specifically, this system includes a micro-emitter array including a first emitter; a first sample of the substance deposited on the first emitter; and an electromagnetic-radiation detector including a first-detecting element positioned to to receive a reading from the first sample after the first sample has been irradiated by a first source of electromagnetic energy originating from the first emitter. These embodiments may also include a second emitter on the micro-emitter array: a second sample of the substance deposited on the second emitter; a second-detecting element positioned to to receive a reading from the second sample after the second sample has been irradiated by a second source of electromagnetic energy originating from the second emitter.

In other alternative embodiments the system includes a micro-emitter array including a first emitter and a second emitter the first and second emitters being mounted on a first surface of a substantially transparent substrate, the substantially transparent substrate being flip-chip mounted onto a primary substrate, the primary substrate including driver circuitry, an opposite surface of the substantially transparent substrate, the opposite surface including a first receptacle for receiving a first sample of the substance and a second receptacle for receiving a second sample of the substance; and an electromagnetic-radiation-measuring detector including: (i) a first-detecting element positioned to receive a reading from the first sample the first sample has been irradiated by a first source of electromagnetic energy, the first source having originated from the first discrete emitting element, and (ii) a second-detecting element positioned to receive a second reading from the second sample after the second sample has been irradiated by a second source of electromagnetic energy originating from the second discrete emitting element.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1. is a schematic diagram showing integration of a III-nitride micro-emitter array with a biochip and a detector (or detector array or CCD).

FIGS. 2A-D show an example of a III-nitride micro-emitter array that has 128×128 pixels.

FIG. 3. shows Emission spectra of InAlGaN based visible micro-size emitters fabricated. The emission wavelength is controlled by varying the alloy composition.

FIG. 4A shows a current-voltage (I-V), and FIG. 4B shows a power-current (L-I) characterization of a pixel micro-emitter with a diameter of 18 μm. The emission wavelength of this micro-emitter is at 450 nm.

FIG. 5. shows an emission spectrum of an InAlGaN based 280 nm deep UV micro-size emitter fabricated. The emission wavelength can be controlled, by varying the alloy composition, down to 220 nm.

FIG. 6. is a schematic diagram showing the integration of a III-nitride micro-emitter array, a biochip, and a detector (or a detector array or a CCD). A micro-lens array may be incorporated for enhanced light concentration. The micro-emitter array driver may be of passive type, in which case the micro-emitters and the interconnection between the micro-emitters (the signal transmission paths, including all the n-lines and p-lines), may all be integrated onto the III-nitride wafer.

FIG. 7. is a schematic diagram showing the integration of a III-nitride micro-emitter array, a biochip, and a detector (or a detector array or a CCD). A micro-lens array may be incorporated for enhanced light concentration on the sapphire substrate side. The micro-emitter array may be flip-chip bonded to an active driver, such as an integrated circuit die, in which case the micro-emitter array may be heterogeneously integrated with the driving circuit through flip-chip bonding using indium or other type of adhesive bumps.

FIG. 8 is a schematic diagram showing the integration of a III-nitride micro-emitter array, a biochip, and a detector (or a detector array or a CCD). An array of tagged DNA or protein sequences is directly printed above an InAlGaN micro-emitter array.

FIG. 9 is a schematic diagram showing the integration of a III-nitride micro-emitter array, a biochip, and a detector (or a detector array or a CCD). An array of tagged DNA or protein sequences is directly constructed on a sapphire substrate, which is also the micro-emitter array substrate.

### DETAILED DESCRIPTION

Embodiments of the present invention provide systems and methods for testing biological materials. More specifically, using biological and medical sensors which are based on III-nitride micro-emitter arrays (e.g., like those disclosed in U.S. Pat. No. 6,410,940, the contents of which are herein incorporated by reference. It should be recognized that the embodiments of this invention are not necessarily limited to only III-nitride emitter arrays. For example, for fluorescence-based DNA microarrays, the current technologies use red, green, and in some cases, blue and UV as excitation wavelengths. Thus, the array is not necessarily GaN materials depending on the application. The materials selected will depend on the wavelength desired. For example, if the demand is for green, blue, or UV, then GaN could be selected. If the demand was for red, then AlGaInP might be selected. For protein intrinsic fluorescence excitation applications, which require deep UV, AlGaN would be proper. In embodiments, a portable (or handheld) sensor integrates an emitter array based on InAlGaN materials, a fluorophore-labeled DNA micro-array, and a detector (or detector array or charge-coupled device, “CCD”) for analyzing DNA sequence and disease detection. In another embodiment, a portable (or handheld) sensor integrates a deep ultraviolet (“UV”) (≦280 nm) emitter array based on InAlGaN alloys, a label-free protein micro-array, and a detector (or detector array or CCD) for investigation of protein-protein interactions and detection of biological and chemical molecules with high specificity by monitoring changes in a protein's intrinsic fluorescence.

Embodiments of the integrated DNA micro-emitter array contain no moving parts, while a conventional laser setup requires moving parts (e.g., mirrors) to adjust the beam to each specific DNA dot on a biochip.

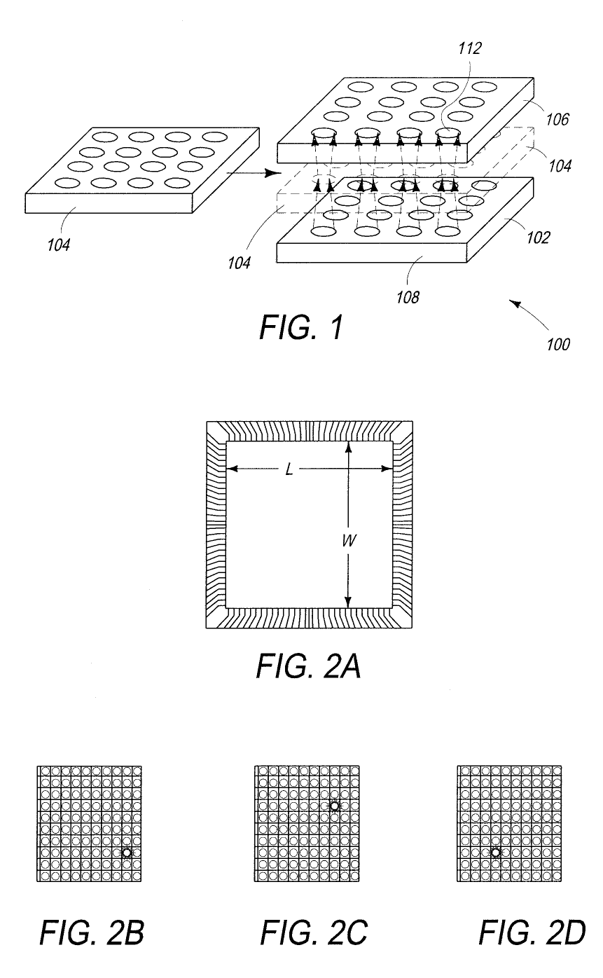

Referring to FIG. 1, a biological or medical sensor 100 is generated by heterogeneously integrating an emitter array 102 based on InAlGaN materials, a fluorescence-labeled DNA micro-array 104, and a detector 106 (or a detector array or a CCD) for analyzing DNA sequence with decreased volume and cost, but increased throughput. Because it is so small, sensor 100 is portable. This is accomplished by integrating deep UV (≦280 nm) emitter array 102, which in embodiments is based on InAlGaN alloys, label-free protein micro-array 104, and detector 106 (or detector array or CCD) for investigations of protein-protein interactions and the detection of biological and chemical molecules with high specificity by monitoring the changes in protein's intrinsic fluorescence. The DNA or protein micro-array is adapted to be replaceable in that it can be inserted to be sandwiched between emitter 102 and detector 106 and then removed. When integrated with a detector array made of InAlGaN or Si or other semiconductor materials, the entire sensor can be made at very low cost (e.g., can be considered disposable).

Micro-emitter array 102 provides single-wavelength very concentrated spots of light and is therefore much more energy efficient than is lamp light. Additionally, micro-emitter array 102 would be capable of varying light output through each pixel so that it can be used in place of both the conventionally-used laser and filtered lamp arrangements. Micro-emitter array 102 has the capability of turning on individual pixels in an automated fashion. Through proper programming, the pixels are individually able to be turned on and off in a fashion similar to a laser scan. This allows the micro-emitter array to be used with a PMT, while simultaneously turning on many pixels will create fairly high intensity light of a single wavelength allowing the micro-emitter array to be used with a CCD camera to provide a very high signal/noise ratio.

In the integrated array sensor, there are an equal number of micro-emitters and sensing spots. An emission from each micro-emitter couples to a corresponding sensing spot to excite fluorescence, and a fluorescence emission from each sensing spot is detected by a corresponding detector element or group of detector elements. Between the detector array and the sensing array, a suitable filter, not shown in embodiments, may be used to block the excitation light from the micro-emitter array. Detection may be based on fluorescence intensity, but other fluorescence detection methods, such as fluorescence lifetime, may also be used.

Referring to FIGS. 2A-D, an embodiment of a III-nitride micro-emitter array having 128 by 128 pixels is shown that is based on InAlGaN semiconductor materials. A micro-emitter structure typically contains a buffer layer, an n-type semiconductor layer, an activation quantum well region and a p-type semiconductor layer and may be grown on a variety of substrates such as sapphire (Al2O3), silicon carbide (SiC), silicon (Si), gallium nitride (GaN), aluminum nitride (AlN), gallium arsenide (GaAs) and indium phosphide (InP), for example. Each micro-emitter has an anode constructed on p-type semiconductor layer, and a cathode on n-type semiconductor. Micro-emitters are arranged into a matrix array format to form a micro-emitter array. In the FIG. 2A embodiment, the optically active region has a length (l) equal to its width (w), each equaling 2.5 mm, or approximately 2.5 mm. Numerous other sizes or shapes could, of course, be presented which would fall within the scope of the invention.

There are three approaches that can be used to build a micro-emitter array. The approach depends on how the user wishes to control the micro-emitter array—by independent driving, passive driving, or active driving. For independent driving, each micro-emitter has an independent anode and cathode, and can be independently turned on and off. For passive driving, all the micro-emitters on each row share a common electrode, and all the micro-emitters on each column share the other common electrode. For active driving, all the micro-emitters in the array share a common electrode, and the other electrode for each micro-emitter is independent. FIGS. 2B-D show an arrangement where in each figure a different pixel is illuminated at a different time. It should be noted, however, that the arrangement could be such that sections of pixels are programmed to be illuminated at once, or even the entire array of pixels if desired.

Referring back to FIG. 1, a corresponding isolated emitter 108, biological material dot 110, and detector 112 are shown. To integrate micro-emitter array 102 with DNA/protein micro-array 104, each micro-emitter (e.g., emitter 108) on the micro-emitter array 102 may have a substantially similar or smaller dimension as that of a corresponding micro-array dot (e.g., dot 110). For example each micro-emitter may be approximately 2 μm or larger, with a pitch that is matched to that of the micro-array. In terms of structural arrangement, the micro-emitter array 102 may be integrated on the same substrate and isolation between adjacent micro-emitters is accomplished by trench etching to remove conductive materials down to the insulating substrate (or to an insulating layer sandwiched between the micro-emitter structure and the conductive or insulating substrate). This insulating layer may be epitaxially grown on the substrate and its composition and thickness should be selected so that a subsequent micro-emitter material structure is thin enough (less than 3.5 micro meters, for example), so that isolation trench etching between adjacent micro-emitters can be easily accomplished. Other approaches based on surface planarization with spin-on polymers or deposited insulators can also be adapted for the fabrication of III-nitride micro-emitter arrays. A p-contact (anode) and an n-contact are formed separately on the p-type layer and n-type layer so that a forward bias voltage may be applied to the emitter array to stimulate light emission.

A feature of micro-emitter arrays based on III-nitrides is that the wavelength range, and with the particular embodiments using InAlGaN materials is that the system covers the entire spectrum of visible light through deep UV and can be tuned to match commonly used fluorescent labeling dyes. An array of tagged DNA or protein sequences printed above an InAlGaN micro-emitter array can be probed by examining emitted light in spectroscopic intensity. A comparison of a sensor based on III-nitride micro-emitter arrays with sensors based on other technologies is provided in Table 1 below.

TABLE 1
Comparison of integrated micro-emitter array embodiments
with existing technologies for DNA micro-array applications.

| | Laser | Lamp/Filter | Micro-emitter Array |
|---|---|---|---|
| Moving Parts | Yes | No | No |
| Light Intensity | Very High | Medium | High & Adjustable |
| Spatial Resolution | Very High | Low | High & Adjustable |
| Speed | Slow | Fast | Fast & Adjustable |
| Works with CCD | No | Yes | Yes |
| Work with PMT | Yes | No | Yes |
| Scan one pixel at | Yes | No | Yes |
| one time | | | |
| Scan one section | No | Yes | Yes |
| within a micro- | | | |
| array at one time | | | |
| Scan entire micro- | No | Yes | Yes |
| array at one time | | | |
| Integration with | No | No | Yes |
| semiconductor | | | |
| detector array | | | |

Significant benefits can potentially be obtained by utilizing deep UV emitter arrays using III-nitride wide bandgap semiconductors as the excitation source. Use of InAlGaN deep UV emitter and detector arrays provides the essential elements for compact portable (handheld) and low cost protein micro-arrays for the applications in molecular biology and medicine.

Other types of sensors may integrate a molecule capture array (such as an aptamer or thioaptamer array) with a deep UV micro-emitter array to detect biological and chemical molecules with high specificity and sensitivity, and low false positives. In these sensors, the molecule capture array is capable of binding one or more types of molecules (or particles) with exceptional specificities. The deep UV light source and detector will essentially provide a “yes” (or “no”) answer if the unknown molecules (or particles) bind (or not)—if binding occurs, intrinsic fluorescence will be detected.

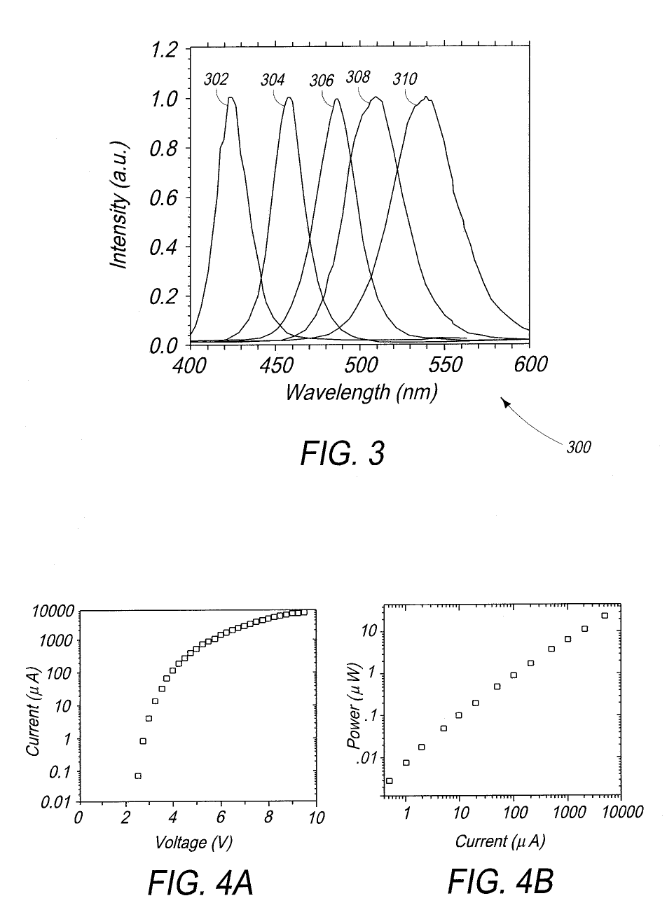

Referring to FIG. 3, a chart 300 is provided which shows that micro-size emitter arrays with different emission wavelengths, for example purple, blue, and green, can be achieved by optimizing indium composition in multiple quantum well active layers of the InAlGaN emitter structure. For example, a first plot 302 shows the output obtained from an emitter having a first composition, a second plot 304 shows an output from an emitter having a second composition, a third plot 306 shows an output from an emitter having a third composition, a fourth plot 308 shows an output from an emitter having a fourth composition, and fifth plot 310 shows an output from an emitter comprised of a fifth composition. Thus, unlike the conventional laser or lamps used in presently available micro-array systems, an excitation wavelength of a III-nitride emitter array can be specified and designed to match the analysis when seen as desirable by the technician depending on the type of micro-array analysis being performed.

Referring to FIGS. 4A and 4B, the emission intensity or the optical power of the III-nitride micro-emitter arrays can easily be adjusted by adjusting the applied current.

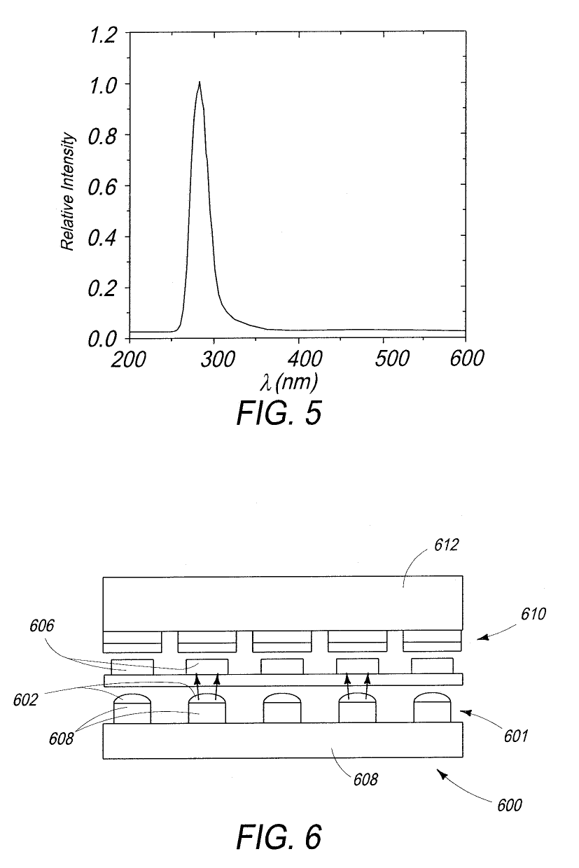

Referring to FIG. 5, micro-emitter arrays with emission wavelengths down to deep UV, 280 nm for example, can be achieved by optimizing the aluminum composition in multiple quantum well active layers of the InAlGaN emitter structure. Presently available systems for proteins' intrinsic fluorescence detection employ mode-locked Ti:Sapphire lasers, from which the UV wavelength is achieved by generating frequency doubled output (420 nm) in a frequency doubler crystal and mixing the doubled radiation with the fundamental radiation in a second nonlinear crystal, currently provided only by a laboratory bench-top set up that is not portable. Replacing the Ti:Sapphire laser with III-nitride deep UV micro-emitter array allows a lab-on-a-chip approach which makes the user able to easily relocate the device.

It should be recognized that FIG. 1 shows a high-level, more generic embodiment of a particular micro-emitter arrangement employed, but that FIGS. 6-9 show more particular arrangements.

Referring to FIG. 6, an alternative embodiment 600 is shown. Embodiment 600 includes an emitter assembly 601 which includes a micro-lens array 602 which is integrated with an emitter array 604 mounted on a substrate 608 to enhance the excitation light concentration and spatial resolution, and to decrease the crosstalk between different DNA spots. The array can be programmed to scan each pixel one by one or to scan sections of a micro-array 606 or the entire array 606 at the same time. The micro-emitter array driver (incorporated onto a substrate 608) may be of passive type, in which case the micro-emitters are arranged in X-Y matrix format. The cathodes of all the micro-emitters in each row are connected together to form a common cathode for this row, and the anodes of all the micro-emitters in each column are connected together to form a common anode for this column. These interconnection between the micro-emitters (the signal transmission paths are also integrated on the same III-nitride wafer. The III-nitride wafer includes a substrate, a n-type III-nitride semiconductor mater, a multi-quantum well as the light emission region, and a p-type III-nitride semiconductor layer. The micro-emitter array fabrication starts from partially etching off all the semiconductor layers to form electrically isolated strips. On each strip, a row of micro-emitters will be fabricated. Next, the each micro-emitter area is defined by etching off the semiconductor layers down to n-type layer to form narrow gaps between neighboring micro-emitters on each row. Metal strips are deposited along the row direction to form a common cathode for all the micro-emitters on each row. After proper isolation, metal strips are deposited along the column direction to form a common anode for all the micro-emitters on each column. Readings are taken using a detector array or CCD arrangement 610 deposed on a Read Out Integrated Circuit (ROIC) 612.

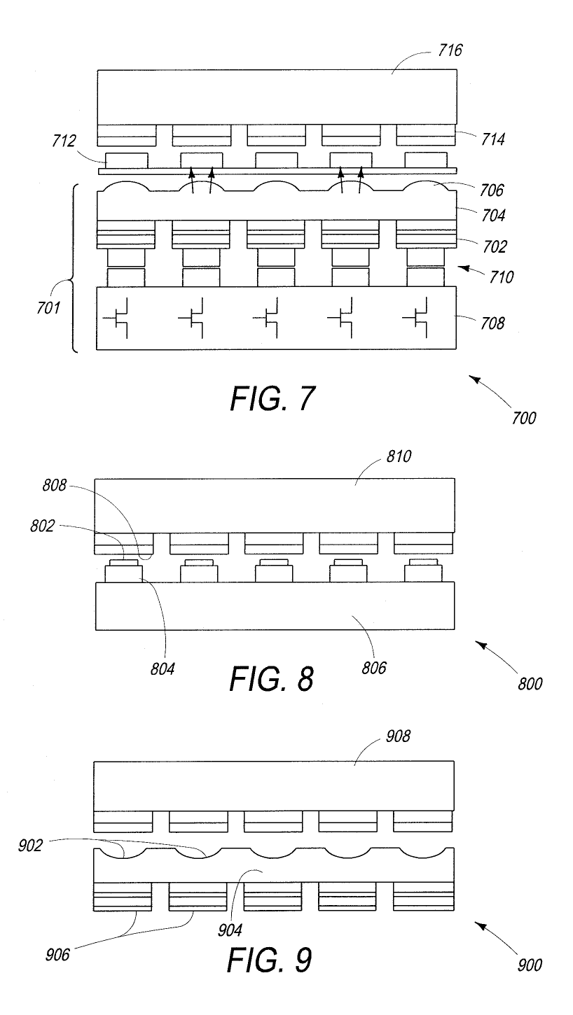

FIG. 7 shows another sensor embodiment 700. Arrangement 700 includes a III-nitride micro-emitter array 702 grown on a transparent substrate 704. Substrate 704 in the disclosed embodiment, is comprised of sapphire, but could be comprised of other like materials. A micro-lens array 706, in this embodiment defined by the upper surface of the sapphire substrate 704, is helpful in: (i) enhancing the excitation light concentration and spatial resolution; and (ii) decreasing the crosstalk between different DNA spots. The array 702 can be programmed to scan each pixel one by one or to scan sections of a micro-array or the entire array at the same time. The micro-emitter array 702 is fabricated from a III-nitride wafer which includes a substrate, a n-type III-nitride semiconductor mater, a multi-quantum well as the light emission region, and a p-type III-nitride semiconductor layer. The micro-emitter array fabrication initially involves partially etching off the semiconductor layers to n-type layer to form narrow gaps between neighboring micro-emitters. The bottom n-type semiconductor layer for all the micro-emitters is still continuous. A metal contact formed on this n-semiconductor layer is the common cathode for all micro-emitters in the array. On the mesa top surface of each micro-emitter, an individual metal contact as anode is deposited on the p-type semiconductor. The micro-emitter array 702 thus formed is flip-chip bonded to an active driver 708, such as a Si VLSI driving circuit die or highly integrated CMOS circuit, in which case the micro-emitter array is heterogeneously integrated with the driving circuit through flip-chip bonding using indium bumps, e.g., indium bumps 710, or other type of adhesive bumps. Each bump connects with the anode of one micro-emitter. In addition, one special bump which is the electrical ground of the driving circuit chip, is connected with the common cathode of the micro-emitter array. The driving circuit consists of an equal number of driving unit as the number of micro-emitters. Each driving unit in the driving circuit will drive its corresponding micro-emitter. Again, the emissions from array 702 through transparent substrate 704 and microlenses 706 are directed into a replaceable DNA or protein microarray 712, and readings are taken into a detector array or CCD 714 disposed on an ROIC 716.

This hybrid configuration 700 of a micro-emitter array has the discrete micro-emitter matrix array 702 in one layer (called micro-emitter array die), and the interconnected signal transmission lines in the other layer 708 (called substrate). These two layers are then flip-chip bonded together with indium bumps 710 without requiring the etching down to the insulating substrate to form the isolated n-GaN strips. All the micro-emitters in array 702 now have their n-type GaN layers connected, and all the p-contacts are left open with the indium bumps, and will be connected to the substrate layer. Furthermore, substrate 708 not only just contains the signal transmission paths to interconnect each discrete micro-emitter; it is an integrated driving circuit. This hybrid structure will provide the following benefits: First, by removing the interconnected n- and p-metal lines and the related large isolation spaces required, the light emitting area for each individual micro-emitter is able to be located directly across from the corresponding pixel area. Thus, the fill factor for the micro-emitters is able to be increased to the point that fairly densely packed detector arrays, or CCD units can be accomodated with opposing micro-emitters in a one-on-one relationship. Second, the much simplified micro-emitter array structure means the processing steps of the micro-array itself is dramatically reduced. This is because there is no need to etch the circuitry onto the sapphire. As a result, the surface damage caused by deep plasma etching can be minimized, and the emitter emission efficiency and luminance will be further improved. Because the flip-chip arrangement enables the electrical connections to be made through the driver circuit substrate 708 rather than on the saphire substrate/GaN die 704, numerous processing steps are thus transferred from the fabrications of GaN die 704 to the support chip (e.g., driver-circuit substrate 708). The technologies for fabricating driver circuitry onto substrates like substrate 708 are much more mature, thus, the arrangements like that reflected in hybrid emitter array 700 should have better yield, be less expensive, and be more efficient. Third, the hybrid integration of the GaN micro-emitter array die with the Si VLSI driving circuit die in one flip-chip bonding package means thousands of the signal connections between the micro-emitter array and the driving circuit have been accomplished in the package through the indium bumps rather than through deposited wires on the III-nitride semiconductor wafer. For arrays having an area on the scale of 1 cm², crystalline silicon wafers and highly integrated CMOS technologies can be adapted to serve as the driving circuit. Since the micro-emitter emission intensity depends on the injected current, the driving circuit design is based on constant current driving design. Each driving unit typically consists of one capacitor and several transistors. The common practice of driving circuit design for organic light-emitting diode display may be adopted here.

Referring to FIG. 8, yet another sensor embodiment 800 is shown. In this embodiment, discrete samples of biological material to be tested, e.g., sample tagged DNA or protein sequence 802, are deposed directly (e.g., printed) onto each individual micro-emitter, e.g., emitter 804. In this embodiment, an InAlGaN micro-emitter array is fabricated onto a sapphire, silicon, or silicon carbide substrate used. Like in past embodiments, each emitter (e.g. micro-emitter 804) and sample (e.g., biological material 802) is associated with and caused to be located directly underneath a particular detector in a detector array or CCD pixel 808 which are a component of an ROIC 810. The micro-emitter array used here has essentially the structures as those described for the embodiments of FIG. 6 or FIG. 7. The FIG. 8 device is different from the FIG. 6 and FIG. 7 embodiments in that the replaceable DNA or protein microarray substrate is removed, and the sample array is directly formed on the top surface of micro-emitter array.

Referring to FIG. 9, an embodiment 900 is disclosed in which the DNA or protein micro-array (not shown, but at positions 902) is directly constructed onto or into a sapphire substrate 904. The micro-emitter array 906 in this embodiment is deposed onto the saphire substrate 904, then flipped relative to the detector/CCD array on the ROIC 908. Thus, the micro-emitter array and its driving circuit are enclosed with only the sapphire substrate backside exposed. In embodiments, this backside has etched wells 902 used for DNA or protein attachment. The enclosure of micro-emitter array ensures that the illumination features will not be exposed to the materials introduced, and therefore, that the sapphire surface will be reusable. The micro-emitter array 906 here has the same structures of the embodiments of FIG. 6 or FIG. 7. The difference here is that the replaceable DNA or protein microarray substrate is removed, and the sample array is directly formed on the reverse side of the transparent sapphire substrate.

In other embodiments, the sensor may integrate a molecule capture array (such as an aptamer or thioaptamer array) with a deep UV micro-emitter array to detect biological and chemical molecules with high specificity and sensitivity, and low false positives. In these sensors, the molecule capture array is capable of binding one or more types of molecules (or particles) with exceptional specificities. The deep UV light source and detector will essentially provide a “yes” (or “no”) answer if the unknown molecules (or particles) bind (or not)—if binding occurs, intrinsic fluorescence will be detected.

By heterogeneously integrating a DNA micro-array, light sources and detectors into a single substrate/package, embodiments herein provide compactness, low cost, high speed, easy operation, high reliability and high functionality because of the inherent advantages of reduced parts count, size and weight of the overall system, as compared with presently available systems. Micro-emitter arrays based on III-nitride wide bandgap semiconductors may be utilized. Embodiments herein offer the possibility for heterogeneous integration of a light source including a plurality of discretely controlled micro-emitters, micro-array chip, and detector into a single substrate or package with many advantageous features. Since III-nitride micro-emitter arrays emit light with an adjustable wavelength (from visible through UV) which can be used in DNA sequencing, III-nitride micro-emitter arrays can be integrated with micro-assays of biological samples and CCD or micro-size detector arrays.

This is an improvement considering that size minimization of the conventional systems is restricted by the unreduceable laser scanners which are used in conjunction with a PMT. This is because the laser and PMT cannot be sufficiently compacted. Further, the size of the current technology using a lamp and CCD setup is limited by the size of the lamp. Replacing these two conventional light sources with a micro-emitter array greatly reduces the size of the entire setup and reduces the entire system such that it is able to be incorporated into a handheld device or even reduced to a lab-on-a-chip scale. The entire biochip scanning setup, in embodiments, would be a single device with no moving parts.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A sensor system used for the purpose of determining a characteristic in a substance, said substance being one of a chemical and a biological agent, said system comprising:
a sample-deposition member being locatable between a micro-emitter array and an electromagnetic-radiation-measuring detector, said sample-deposition member including a first sample deposit;
said micro-emitter array including a first discrete emitting element; and
said detecter including a first-detecting element positioned to receive a reading from said first sample after said first sample has been irradiated by a first source of electromagnetic energy originating from said first discrete emitting element.

2. The system of claim 1 comprising:
a second sample deposit on said deposition member;
a second discrete emitting element on said micro-emitter array; and
a second-detecting element positioned to to receive a reading from said first second sample after said second sample has been irradiated by a second source of electromagnetic energy originating from said second discrete emitting element.

3. The system of claim 2 wherein at least one of said first discrete emitting element and said second discrete emitting element emit UV electromagnetic energy.

4. The system of claim 2 wherein at least one of said first discrete emitting element and said second discrete emitting element emit at wavelengths of approximately 280 nm.

5. The system of claim 1 wherein a plurality of individual emitters in said micro-emitter array are adapted to be individually turned on and off.

6. The system of claim 1 wherein said detector is one of a detector array and a CCD.

7. The system of claim 6 wherein said detector has a read out integrated circuit.

8. The system of claim 1 wherein said micro-emitter array and said detector are arranged such that said sample-deposition member is removeable and replaceable.

9. The system of claim 1 wherein a microlens is deposed on said first discrete emitting element to focus electromagnetic energy emitted on said first sample.

10. The system of claim 1 wherein a substrate on which said first discrete emitting device is mounted includes a driver-circuit arrangement necessary to electrically control said first discrete emitting element.

11. The system of claim 1 wherein said first discrete emitting element is mounted on a first surface of a substantially transparent substrate, said substantially transparent substrate being flip-chip mounted onto a primary substrate, said primary substrate including driver circuitry.

12. The system of claim 11 wherein electrical connections between said first discrete emitting element and a plurality of other discrete light emitting elements and said driver circuitry on said primary substrate are made using indium bumps.

13. The system of claim 11 wherein an opposite side of said substantially transparent substrate defines at least one microlens for columnating the electromagnetic energy emitted from said first discrete emitting element on to said first sample.

14. The system of claim 1 wherein said micro-emitter array is constructed of III-nitride materials.

15. The system of claim 1 wherein said micro-emitter array is a III-nitride micro-emitter array.

16. The system of claim 15 wherein said micro-emitter array is constructed of InAlGaN alloy materials.

17. A sensor system used for the purpose of determining a characteristic in a substance, said substance being one of a chemical and a biological agent, said system comprising:
a micro-emitter array including a first emitter;
a first sample of said substance deposited on said first emitter; and
an electromagnetic-radiation detector including a first-detecting element positioned to to receive a reading from said first sample after said first sample has been irradiated by a first source of electromagnetic energy originating from said first emitter.

18. The system of claim 17 comprising:
a second emitter on said micro-emitter array:
a second sample of said substance deposited on said second emitter;
a second-detecting element positioned to to receive a reading from said second sample after said second sample has been irradiated by a second source of electromagnetic energy originating from said second emitter

19. A sensor system used for the purpose of determining a characteristic in a substance, said substance being one of a chemical and a biological agent, said system comprising:
a micro-emitter array including a first emitter and a second emitter said first and second emitters being mounted on a first surface of a substantially transparent substrate, said substantially transparent substrate being flip-chip mounted onto a primary substrate, said primary substrate including driver circuitry,
an opposite surface of said substantially transparent substrate, said opposite surface including a first receptacle for receiving a first sample of said substance and a second receptacle for receiving a second sample of said substance; and
an electromagnetic-radiation-measuring detector including: (i) a first-detecting element positioned to receive a reading from said first sample said first sample has been irradiated by a first source of electromagnetic energy, said first source having originated from said first discrete emitting element, and (ii) a second-detecting element positioned to receive a second reading from said second sample after said second sample has been irradiated by a second source of electromagnetic energy originating from said second discrete emitting element.
